(19) United States
(12) Patent Application Publication
(10) Pub. No.: US 2014/0012521 A1
(43) Pub. Date: Jan. 9, 2014

(54) Methods for Eddy Current Data Matching

(71) Applicant: Jeff Strizzi, Kirkland, WA (US)

(72) Inventor: Jeff Strizzi, Kirkland, WA (US)

(73) Assignee: ZETEC, INC., Snoqualmie, WA (US)

(21) Appl. No.: 13/542,957

(22) Filed: Jul. 6, 2012

(51) Int. Cl. G01N 27/90; G06F 19/00

(52) U.S. Cl. 702/58

(57) ABSTRACT

A method of analyzing historic and current eddy current test probe data is disclosed. The method takes into account that the two data sets of data may not be an exact match in acquisition technique based on factors such as probe pull speed, direction, record leg or instrument configuration. The method includes the steps of aligning a first set of eddy current data to a second set of eddy current data based on prominent features found in both data sets; converting the first set of eddy current data to a modified first set of eddy current data to match the second set of operating conditions and; comparing the modified first set and the second set to find change over time.

### BACKGROUND OF THE INVENTION

1. Field of Invention

The present invention relates to eddy current monitoring and analysis systems and methods.

2. Description of Related Art

The process of testing metal for failure with eddy current probes is well known in the art. Further, the use of this technology in the field of boiler tube testing is also well known. In the field of automated monitoring and analysis systems and processes with eddy current testing of tubing, there remains a need for analyzing tube degradation over time. The direct vertical and/or horizontal signal component change in eddy current signal from year to year could be as interesting as the final present day signal is what led to the attempt to perform pattern matching, interpolation and alignment of physically similar but temporally separated datasets. This task is complicated by the difficulty in comparing most recent eddy current data with previous readings. There is value to the temporal change in any eddy current data signal, above and beyond that which can be derived based strictly on the current signal of interest alone. Correlation and alignment of the data such that each point has a physical analog separated by time is of immense value to the decision making process of automatically detecting and classifying signals of interest in eddy current data.

In the past, operators of steam tubing equipment have had to rely on comparison of analysis results over time, as opposed to the original raw data-files, which introduces an unacceptable margin-of-error, which ultimately translates in an insufficient confidence that rate-of-change of tube degradation is captured accurately and reliably.

Moreover, the available software tools for analyzing eddy current data continue to evolve. In order to use the current tools to compare past data in a meaningful way, raw historic data must be aligned with current data.

There remains a need for systems and methods for comparing raw eddy current data over time to better pinpoint possible developing tube flaws.

This application refers to Zetec®'s automated-analysis-product (RevospECT). A related patent application, which includes descriptions of that product, is entitled “Methods for Automated Eddy Current Non-destructive Testing Analysis” and bears U.S. application Ser. No. 12/689,576.

All references cited herein are incorporated herein by reference in their entireties.

### BRIEF SUMMARY OF THE INVENTION

### Brief Description of Several Views of the Drawings

The invention will be described in conjunction with the following drawings in which like reference numerals designate like elements and wherein:

FIG. 1 is a flow diagram of an exemplary process for analyzing current and historic eddy current test data; and

FIG. 2 is a flow diagram of an exemplary process to align historic data files with current data.

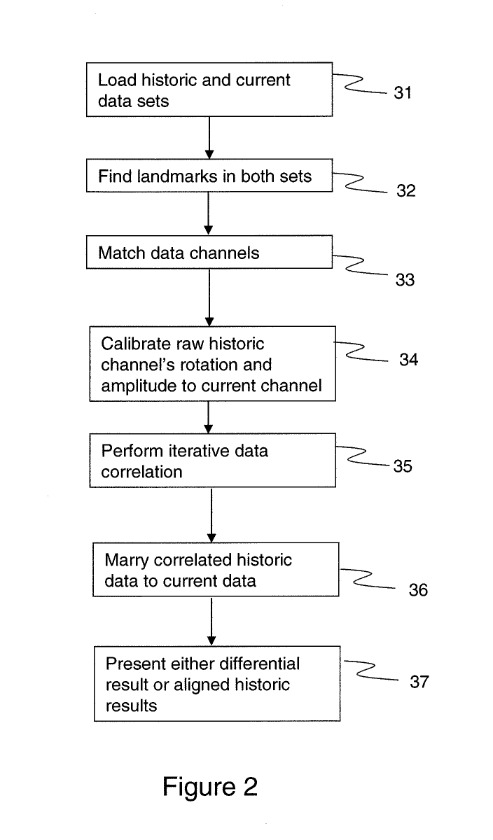

### DETAILED DESCRIPTION OF THE INVENTION

Described herein is a process for historical-to-recent eddy current data-matching, comparison, and integration into automated analysis decision process (“Auto-HDC”). The process makes possible the use of pattern-matched, interpolated and aligned historical data directly within an automated system as an aid to decision making during detection and characterization of signals in current data. This process gleans possible tube flaw information from signals that are otherwise apparently uninteresting when viewed as a single set of data for a test run at a single point in time.

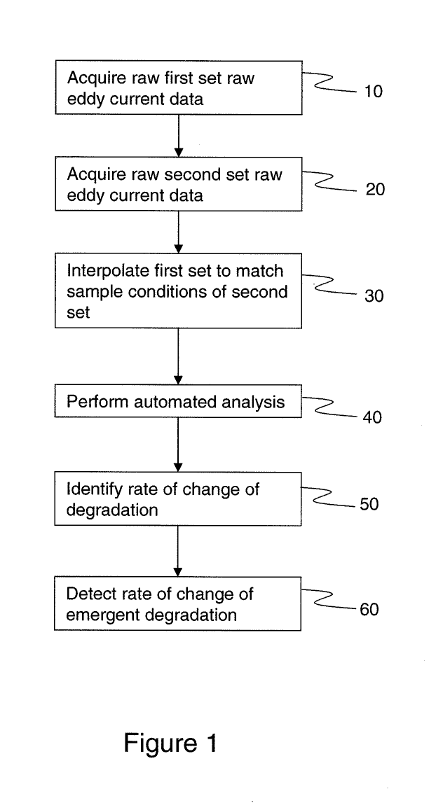

With reference to the flow diagram of FIG. 1, at step 10, raw eddy current data is obtained at a first time. At step 20, raw eddy current data is obtained at a second, later time, presumably long enough after the first time that the results could be expected to differ. At step 30, raw data-files gathered in one or more previous inspections 10 are interpolated so they conform to the acquisition speeds of the second inspection 20 so that the sets of data-files can be properly matched.

Additionally, the analyst configures within an automated analysis system such as Zetec's automated-analysis-product (RevospECT) to take into account the expanded set of available data for comparison. At step 40, the automated analysis system is configured to detect degradation and to classify the degradation using industry standards. At step 50, the system is configured to identify rates-of-change of the degradation experiences over-time. The analyst can then use this new dimension of understanding of degradation (i.e. rate-of-change), to perform a new set of actions that ultimately provide an expanded and a higher-confidence degradation assessment to the customer.

At step 60, the rate-of-change of emergent degradation, wherein the degradation did not exist in previous tests, is also detected. In this case, the change value is the overall value of the degradation.

The details of step 30, in an exemplary embodiment are as follows. At step 31, the appropriate Historical (most recent) and Baseline (first inspection data or oldest available) datasets are identified and loaded automatically into an automated analysis system. These datasets may or may not be an exact match in acquisition technique based on factors such as pull speed, direction, record leg, instrument configuration and the like. At step 32, auto landmark location is performed on all data sets as an initial gross data alignment, and then at step 33, each dataset's individual data channels are matched to a current dataset based on mappings of channel number to channel type. The historical and baseline datasets are then auto-calibrated at step 34 to match the current dataset's rotation and volt scale. Then, at step 35, an iterative correlation/interpolation process is applied to the datasets until they are completely aligned. Once fully correlated and interpolated, historical and baseline data channels are achieved for each sibling channel type, at step 36, the newly aligned data is matched to the corresponding sibling current channel and then at step 37, this data is made available for use either as a differential result of [current-historical] or as a discrete historical view of the data at any point analogous to that point in the current dataset.

This correlated history data and correlated historical change data can then be used for a variety of analyses. A voltage test can be made for example to search for areas of gross voltage change within the data. A delta angle test can be made to see if the signal of interest has undergone a specific window of rotation between the baseline data and the current data. A small indication which may be of little interest in either the current data or the historical data may become more interesting if that signal has undergone some amount of change in either voltage, rotation or both. Conversely, a significant signal that has not changed whatsoever in the last decade may be automatically characterized as less interesting.

The discrete signal change from baseline or historical to current can be used directly as a detection mechanism to identify signals of interest, in addition to detection of signals of interest based on the current data alone. Areas of raw temporal change can then be further interrogated either strictly on the current dataset or both on the current and historical (or baseline) datasets.

Correlated and aligned historical and/or baseline datasets may be fully and independently analyzed as a separate process. Then these historical results compared to the independent current results during a special Final Acceptance result integration process. This process would be more analogous to a widely accepted, and often required, manual history addressing technique, but which until now has been impossible for an automated system to achieve outside of relying on historical report entries alone and ignoring the underlying historical data.

While the invention has been described in detail and with reference to specific examples thereof, it will be apparent to one skilled in the art that various changes and modifications can be made therein without departing from the spirit and scope thereof.

What is claimed is:

1. A method of analyzing eddy current test data comprising:
acquiring a first set of eddy current data from a boiler tube at a first set of test conditions;
acquiring a second set of eddy current data from said boiler tube at a second set of test conditions;
aligning said first set of eddy current data to said second set of eddy current data based on prominent features found in both data sets;
converting said first set of eddy current data to a modified first set of eddy current data to match said second set of operating conditions and;
comparing said modified first set and said second set to find change over time.

2. The method of claim 1, wherein said converting further comprises correlating and interpolating said first set of eddy current data.

3. The method of claim 1 wherein said comparing comprises comparing a voltage level.

4. The method of claim 1, wherein said comparing comprises comparing rotation information.
